(19) United States
(12) Patent Application Publication
(10) Pub. No.: US 2021/0125175 A1
(43) Pub. Date: Apr. 29, 2021

(54) PROCESSING A TRANSACTION USING A MULTIPLE-USE TOKEN

(71) Applicant: PayPal, Inc., San Jose, CA (US)

(72) Inventors: Dinesh Agnello Gomes, San Jose, CA (US); Nitin Prabhu, San Jose, CA (US)

(21) Appl. No.: 17/011,825

(22) Filed: Sep. 3, 2020

Related U.S. Application Data
(63) Continuation of application No. 15/270,836, filed on Sep. 20, 2016, now abandoned.

(51) Int. Cl. G06Q 20/36; G06Q 20/40; G06Q 20/12; G06Q 20/22; G06Q 20/32

(52) U.S. Cl. CPC G06Q 20/36; G06Q 20/405; G06Q 20/32; G06Q 20/227; G06Q 20/12

(57) ABSTRACT

In some embodiments, a method of processing a multiple-use token includes receiving a first request to pay for an online transaction using a digital wallet. The online transaction is between the user and a merchant application. The method also includes generating a multiple-use token corresponding to the online transaction and the digital wallet and sending the multiple-use token to the merchant application. The method further includes receiving a transaction authorization request to pay for a second transaction between the user and a merchant associated with the merchant application, and validating the multiple-use token in accordance with the transaction authorization request and a set of policies defined for the multiple-use token. If the multiple-use token is valid, the digital wallet is charged in accordance with the transaction authorization request.

### CROSS REFERENCED TO RELATED APPLICATIONS

This application is a continuation of U.S. patent application Ser. No. 15/270,836, filed on Sep. 20, 2016, the contents of which are incorporated by reference in its entirety.

### BACKGROUND

### Field

The present disclosure generally relates to systems and methods for processing transactions using multiple-use tokens.

### Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal®, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Many payment transactions enabled by online or mobile payment service providers such as, for example, retail purchases, payment transactions, and the like, are made electronically using electronic devices, such as mobile phones or mobile computing devices. For example, a consumer may install a payment application provided by the payment service provider on his or her mobile device to facilitate payments to various merchants or recipients.

### BRIEF DESCRIPTION OF THE FIGURES

FIG. 1 is an example page that is displayed on a display of a user device by a merchant application.

FIGS. 2A and 2B is an example process flow for issuing a multiple-use token for charging the user's digit wallet.

FIGS. 3A and 3B is an example process flow for charging the user's digital wallet for the initial transaction.

FIG. 4A and 4B is an example process flow for charging the user's digital wallet based on a transaction subsequent to the initial booking transaction.

FIG. 5 is a flowchart illustrating an example method of processing a multiple-use token.

FIG. 6 is an embodiment of a network-based system for implementing one or more processes.

FIG. 7 is a schematic view illustrating an embodiment of a networked system.

FIG. 8 is a perspective view illustrating an embodiment of a user device.

FIG. 9 is a schematic view illustrating an embodiment of a computer system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A user may use a user device to access a merchant application and desire to purchase products and/or services (e.g., collectively referred to as items) provided by a merchant via the merchant application. In an example, the merchant application is a mobile app installed on the user device. In another example, the merchant application is a web application accessible via a uniform resource locator (URL) to which a browser executing on the user device points. The merchant application may provide the user with the option to complete the purchase (or any transaction) using an account the user has with a payment service provider. In an example, the payment service provider is a wallet provider, and the user's account corresponds to a digital wallet provided by the wallet provider.

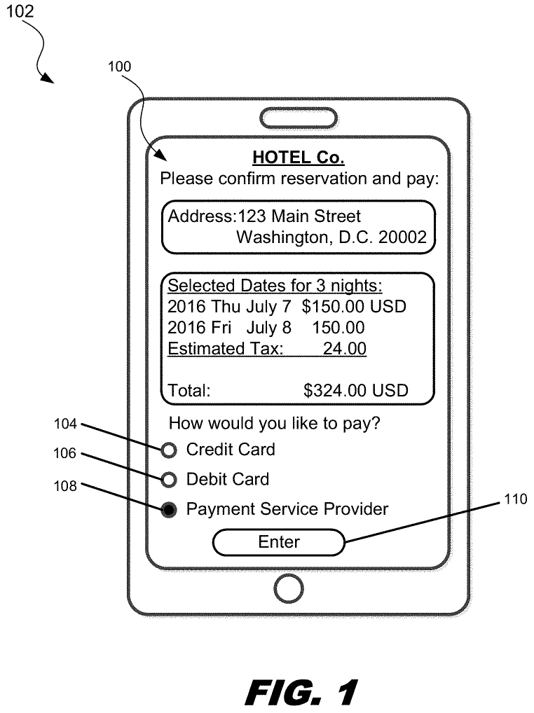

FIG. 1 is an example page 100 that is displayed on a display of a user device 102 by a merchant application. In the example illustrated in FIG. 1, the merchant application is provided by a hotel company named “Hotel Co” and allows users to reserve rooms. As shown on page 100, the user desires to book a stay at Hotel Co., which is located at 123 Main Street, Washington, D.C., for two nights. The user has requested to check into the hotel on Jul. 7, 2016 and check out on Jul. 9, 2016, for $150 USD per night and $24.00 USD in taxes, for an estimated total of $300.00 USD.

Content of page 100 includes the user's selected item(s) (e.g., reservations) along with the price and various ways for the user to pay for the transaction. For example, page 100 includes the option to pay with a credit card via user selectable object 104, debit card via user selectable object 106, or an account the user has with a payment service provider via user selectable object 108. The user's user account with the payment service provider is linked to one or more methods of payment, which may include the user's credit card, debit card, bank account (e.g., checking account), and/or other forms of payment, etc. to which the user has given the payment provider server permission to access. The user may select one of these options by selecting the appropriate user selectable object and selecting a user selectable object 110, which is labeled “Enter,” to confirm the transaction and submit a request to the merchant application to complete the transaction.

If the user selects user selectable object 104 to pay with a credit card, the user may be provided with a prompt to enter credit card information. If the user selects user selectable object 106 to pay with a debit card, the user may be provided with a prompt to enter debit card information. If the user selects user selectable object 108 to pay with the account the user has with the payment service provider, the merchant application may initiate actions to charge this account (e.g., the user's digital wallet). In this example, the merchant application may also have an account setup with the payment service provider in order to receive payments from users.

In an example, the user's account with the payment service provider is a digital wallet what includes one or more methods of payment. In order for the user's digital wallet to be properly charged, the merchant application may request a transactable token from a token service provider. In response to this request, the token service provider generates a transactable token that is consumed by the wallet provider. In some examples, the transactable token includes an expiration date, a token identifier, and a security context. The token identifier may be a number that identifies the token and may be in the same format as a credit card or debit card number. The token identifier may be referred to as a “transactable primary account number” (TPAN) because the token identifier is not an actual credit card or debit card number that can be used as a funding source in and of itself, but is a representation of the transaction and can be used by the merchant to obtain funding for the transaction from the user's linked funding instrument (e.g., the user's digital wallet). In an example, the TPAN is a 16-digit number that represents a payment card (e.g., credit card or a debit card). In an example, the transactable token is a combination of a primary account number (e.g., TPAN), expiry date, and a card verification value (CVV), which may be used once by the merchant for the very first charge.

The transactable token is used to identify a funding instrument to charge. A transactable token is typically a single-use token that is consumed once and then exhausted. An example of single-use token generation and processing is described in U.S. patent application Ser. No. 15/211,657 to Gomes et al., filed Jul. 15, 2016, entitled “Processing a Transaction Using Electronic Tokens,” which is incorporated herein by reference in its entirely. A single-use token is consumed once by the payment service provider and then exhausted. For example, for each transaction requested by the user, a token requestor may request a single-use token from the token service provider, and the token service provider may generate and provide a different token to the token requestor.

It may be desirable to use multiple-use tokens in transactions rather than single-use tokens. In some industries a user makes an online booking, but the actual service is rendered at a physical location. For example, a user desiring to book a hotel or rent a car may make the appropriate reservation via a user interface and pay online, but consumes the offered good and/or service at a physical location (e.g., hotel or car rental location).

In keeping with the hotel example, once the user arrives at the hotel, she may dine at the hotel's restaurant, buy items at the hotel's gift shop, consume beverages residing in her minibar, etc., and desire to use her digital wallet to pay for these goods and/or services. However, merchants typically do not provide this payment option at their physical locations. For example, the user may pay with her digital wallet via page 100 in FIG. 1 because the merchant's website is integrated with the wallet provider. Once the user arrives at Hotel Co., however, she may not have the option of paying this way. For example, the point-of-sale terminals at Hotel Co. may not be integrated with the wallet provider. Accordingly, the user uses her credit card or debit card at the hotel, even though she would rather user her digital wallet to pay for additional transactions with the merchant. It may be desirable to allow the user to pay for one or more transactions while the user is at the merchant's physical location, during the time in which the user is consuming the goods and/or services of the merchant offered through the initial booking (e.g., online hotel reservation).

Referring to the hotel example illustrated in FIG. 1, the merchant already knows the dates that the user plans to stay at the hotel, and the base charge of the initial online booking. The initial online booking refers to the transaction from which a transactable token was generated, and the base charge refers to the transaction amount of the initial online booking. For example, if a transactable token is generated for the hotel stay specified on page 100, the initial online booking refers to the hotel stay and the base charge is $300.00. The estimated taxes may be excluded from the initial transaction amount because it may be uncertain what the actual taxes will be until the user is at the physical location and checks into the hotel.

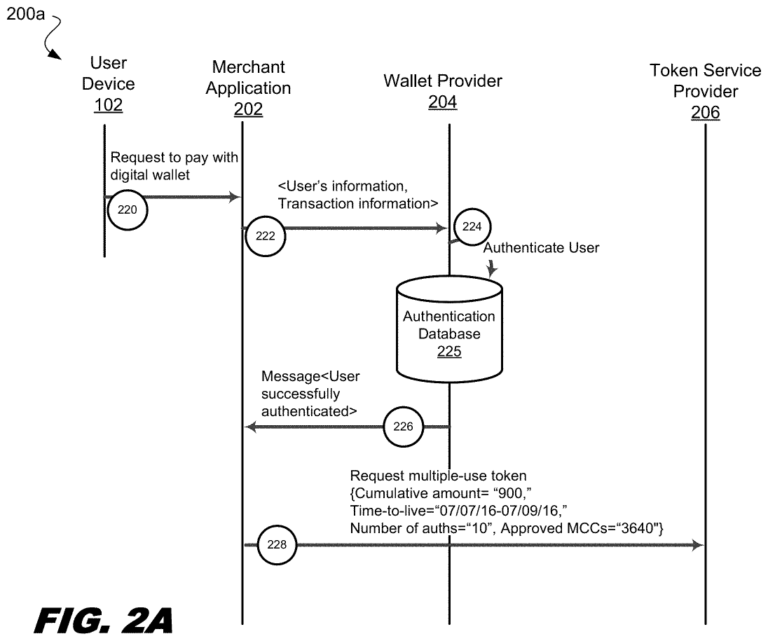

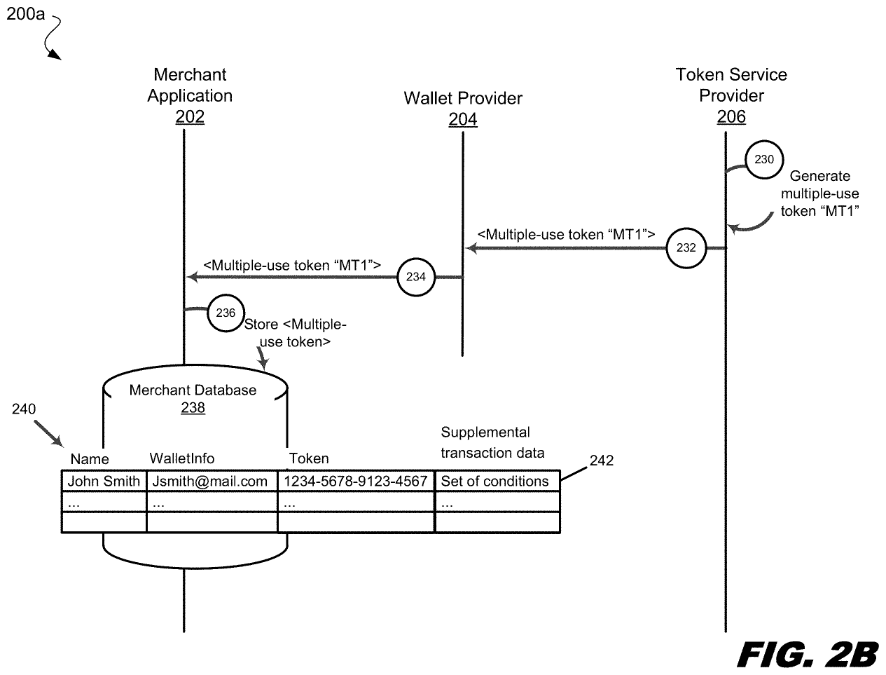

FIGS. 2A and 2B is an example process flow 200a, 200b for issuing a multiple-use token for charging the user's digit wallet. Process flow 200a, 200b shows interactions between a user device 102, merchant application 202, wallet provider 204, and token service provider 206 that lead to the user's digital wallet being charged. Wallet provider 204 may provide the digital wallet to the user, and the digital wallet may include one or more payment methods.

A customer may use user device 102 to execute actions to complete an initial online booking with merchant application 202. A “customer” may also be referred to as a “user” in the present disclosure, and these two terms may be used interchangeably. In some examples, wallet provider 204, token service provider 206, and/or payment server 208 are maintained by the same entity. In some examples, wallet provider 204 and/or token service provider 206 are maintained by different entities and are in a trusted relationship with each other. In an example, token service provider 206 is PAYPAL®, which provides an online payment system to users, and wallet provider 204 is VENMO®, which provides a digital wallet to a user for making and sharing payments with other users. The wallet provider may also be referred to as the payment service provider. In this example, the user has a VENMO® wallet that can be used to pay the merchant, and the payment service provider may charge the user's VENMO® wallet and credit the merchant by the transaction amount. Token service provider 206 may be part of the payment service provider, and generate and process tokens.

The merchant may provide merchant application 202 to users. The user may receive merchant application 202 already installed on user device 102. In another example, the user may download merchant application 202 onto user device 102. In FIG. 2A, at an action 220, user device 102 sends a request to pay with the user's digital wallet. In an example, a user uses user device 102 to select user selectable object 108 displayed on page 100 to send a request to pay for the online booking with the user's digital wallet. The user's request to pay with her digital wallet may be a request to use a funding instrument (e.g., VENMO® account) that is provided by wallet provider 204 to pay for the transaction.

Merchant application 202 receives the request to pay with the user's digital wallet sent by user device 102. At an action 222, merchant application 202 sends the user's information and transaction information to wallet provide 204. In an example, the user's information includes the user's login credentials (e.g., username and password) for accessing services of wallet provider 204, and the transaction information includes the transaction total (e.g., $300). Wallet provider 204 processes payments for merchant application 202. Merchant application 202 may be registered with wallet provider 204. For example, merchant application 202 and wallet provider 204 may be partners in a business relationship and have some trust. In an example, the user provides the user's login credentials for accessing wallet provider 204's services to merchant application 202, which then passes them onto wallet provider 204. In another example, merchant application 202 sends an indication to wallet provider 204 to provide user device 102 with a login page, in which the user enters her user login credentials.

Wallet provider 204 receives the user's information and transaction information sent by merchant application 202. Wallet provider 204 maintains an authentication database 225 that stores user credentials of users authorized to access wallet provider 204's services. At action 224, wallet provider 204 authenticates the user by searching authentication database 225 for the user login credentials provided in the transaction information. If the user login credentials provided in the transaction information are stored in authentication database 225, wallet provider 204 successfully authenticates the user. In contrast, if the user login credentials provided in the transaction information are not stored in authentication database 225, the user is not authenticated and wallet provider 204 may provide an error message to merchant application 202 to inform the merchant application that the user's request to pay has been denied.

If the user is successfully authenticated, wallet provider 204 knows, based on the user's login credentials, the identity of the user attempting to complete the transaction, and process flow proceeds from action 224 to action 226, at which wallet provider 204 sends a message indicating that the user has been successfully authenticated to merchant application 202. If merchant application 202 receives a message indicating that the user has been successfully authenticated by wallet provider 204, process flow proceeds from action 226 to action 228, at which merchant application 202 sends a request for a multiple-use token to token service provider 206. The request may include supplemental transaction data. The supplemental transaction data may be referred to as “supplemental” because this transaction data is not sent in an International Organization for Standardization (ISO)-8583 message. Supplemental transaction data may include various data (e.g., multiple name-value pairs) that does not have corresponding fields in the ISO-8583 message standard. An ISO-8583 message is limited in the amount of detail it provides because it the standard provides for specified fields. Messages for payments may adhere to the ISO-8583 standard. The quality of data sent in the ISO-8583 message depends on the acquirer who set up the merchant. Accordingly, it may be desirable to send supplemental information to token service provider 206 to better process the transaction and to have more information about the user's behavior and the merchant. In an example, the supplemental transaction data includes an external merchant ID that is used to represent the merchant and/or an external transaction reference ID that is used as a unique ID to identify the transaction. The merchant ID and/or transaction reference ID may be retained and stored until the corresponding TPAN expires.

As will be discussed in further detail below, the supplemental transaction data includes a cumulative amount of $1000, time-to-live (TTL) from Jul. 7, 2016 to Jul. 9, 2016 (07/01/16-07/09/16), a number of authorizations (“10”), and approved merchant category codes (MCCs) (“3640”). An MCC is a standard field in the ISO-8583 specification, with the number denoting an industry that the merchant has been assigned (e.g., airline industry, catalog products, etc.), and the exact mapping of the MCC to industry type may be maintained and published by card networks.

In an example, wallet provider 204 invokes an application programming interface (API) exposed by token service provider 206 to cause the supplemental transaction data to be sent to token service provider 206. Although the TTL specified in the supplemental transaction data is the user's check-in date and check-out date, it should be understood that the TTL may allow for a buffer for late charges. For example, the TTL may specify that the multiple-use token is valid three days after the user's check-out date, in case the merchant charges any additional fees associated with the user's initial booking.

Token service provider 206 receives the request for a multiple-use token along with the supplemental transaction data included in the request. Process flow may proceed from action 228 in FIG. 2A to an action 230 in FIG. 2B, in which token service provider 206 generates a multiple-use token “MT1” that may be consumed by the merchant multiple times, and exhausted in accordance with one or more rules, policies, or conditions. The multiple-use token “MT1” is associated with the user of wallet provider 204. Token service provider 206 may generate the multiple-use token “MT1” and define a set of parameters surrounding the multiple-use token “MT1.” One or more parameters of the set of parameters may include, but are not limited to a time element (e.g., TTL, which is the period from the moment of issuance until the multiple-use token expires or is no longer valid); merchant ID (e.g., alphanumeric 32-character ID); transaction reference ID (e.g., alphanumeric 32-character ID); start date of service; end date of service; unit rate; overage amount; allowed merchant category code (MCC) list; memo (e.g., a discretionary data field in which token service provider 206 may include information); and/or merchant business name.

Other parameters may include a card network (e.g., the name of a credit card company's network); scheme/BIN (e.g., debit, credit, prepaid, or token); currency accepted (e.g., US dollars, Euro, Canadian dollar, Vietnamese dong, etc.); merchant information, which may include a choice of merchant preferences such as funding sources, brands, closed loop, dollar limits, etc.; consumer location radius (e.g., GPS coordinates of the user's mobile device); security features (e.g., cryptogram required or step-up authentication required); routing mechanism (e.g., open or closed loop); type of interaction, which may include funding (e.g., private label credit card (PLCC), points, cards, or banks), identity (e.g., access to hotel, gym or car or other environments that need identity verification), and contextual information (e.g., address, etc.); amount (e.g., the amount that can be used for payment authorization using the token); and merchant location, which may be the country in which the merchant is registered (e.g., United States or Canada), terminal location (e.g., Global Positioning System coordinates or registered card reader terminal location), or whether the merchant is online only or offline only. The merchant may be considered online if the service provided by the merchant is being requested over a network (e.g., Internet) with payment being accepted by the merchant over the network. The merchant may be considered offline if the service provided by the merchant is being paid for at a physical location. In some examples, token service provider 206 may generate a multiple-use token with a time element for a one-time authorization for a funding instrument (e.g., digital wallet). A current transaction refers to the transaction for which the user is attempting to charge a funding instrument.

The multiple-use token may be an open-loop token. Token service provider 206 may generate the multiple-use token by generating a TPAN that represents the digital wallet. For example, the TPAN may be used multiple times like a debit card, and is associated with a security scope. The security scope may be represented by the supplemental transaction data included in the merchant's request for the multiple-use token. For example, in FIG. 2A, the security scope includes a cumulative amount that specifies a maximum amount that may be charged for transactions associated with the multiple-use token (e.g., the initial booking and those transactions the user makes upon visiting the merchant's physical location), a TTL that specifies a duration in which the multiple-use token may be valid, a number of authorization charges (e.g., number of auths) that specifies the maximum number of transactions that may be charged in association with the multiple-use token, and a list of approved MCCs that specifies the types of merchants that may charge to the user's digital wallet in association with the multiple-use token. In an example, wallet provider 204 invokes a tokenization API that is exposed by token service provider 206 and that when invoked causes token service provider 206 to generate the multiple-use token. Wallet provider 204 may send the supplemental transaction data as one or more parameters in the API call.

A multiple-use token is a transactable token that may be used for payment or non-payment purposes. In some examples, the multiple-use token serves as a proxy for a funding instrument or an account with the payment service provider. The multiple-use token may be an open-loop or closed-loop ID that serves as a proxy for conveying the user's consent for a particular transaction and for a specific environment. The particular transaction may be a financial or a non-financial transaction corresponding to a specific interaction for that specific environment. An open loop may refer to an ID that is sufficiently recognizable to be routable by existing routing networks (e.g., credit card company networks) back to the token service provider (e.g., PAYPAL®) or other such appropriate ecosystems based on the context of the transaction. A closed loop may refer to an ID that is recognizable only by the token service provider that issued the token or limited ecosystem based on business needs.

The transactable token may represent a manifestation of a common identifier in real time that allows for the enablement of specific transaction(s) in the context and parameter set(s) as defined by the user, environment, and/or token service provider. The transactable token may be a multiple-use token that may represent multiple transactions. For example, the multiple-use token may be used in association with more than one transaction (e.g., the user's hotel stay, dinner at the hotel, and gifts from the hotel gift shop) and exhausted in accordance with policies (e.g., conditions or rules) as defined by the user, environment, and/or token service provider.

At action 232, token service provider 206 sends the multiple-use token “MT1” to wallet provider 204. Wallet provider 204 receives the multiple-use token “MT1” from token service provider 206. At action 234, wallet provider 204 sends the multiple-use token “MT1” to merchant application 202. Merchant application 202 receives the multiple-use token “MT1” from wallet provider 204 and accordingly has information about the user's payment credentials and the TPAN used to pay for the user's initial booking. At action 236, merchant application 202 stores the multiple-use token “MT1” in a merchant database 238, which stores information associated with multiple-use tokens. The multiple-use token “MT1” may be used to pay for multiple transactions, without requesting another transactable token from token service provider 206. Merchant database 238 includes a token table 240 having four columns: Name, WalletInfo, Token, and Supplemental Transaction Data. Table 240 includes an entry 242, which specifies that a user by the name of “John Smith” has an email address “Jsmith@mail.com” and was issued a multiple-use token for an initial transaction. The issued multiple-use token has a TPAN “1234-5678-9123-4567” and is associated with supplemental transaction data including a set of policies.

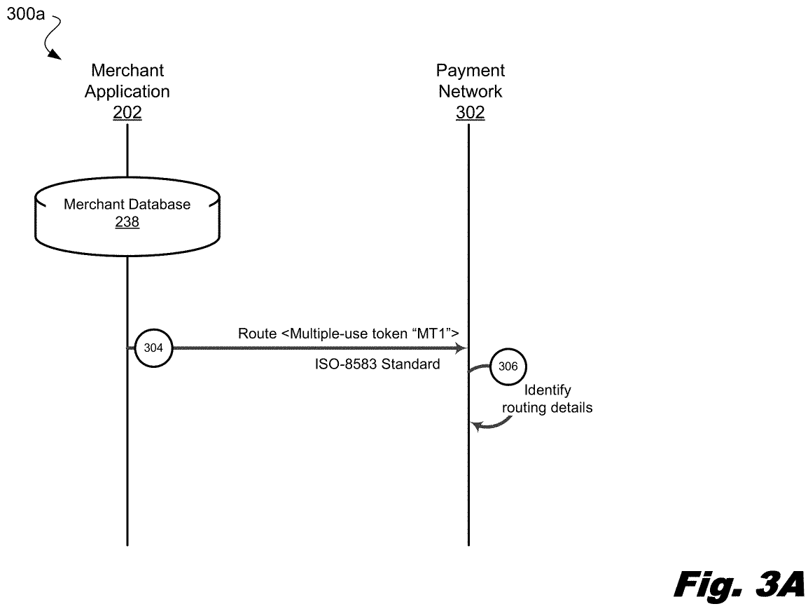

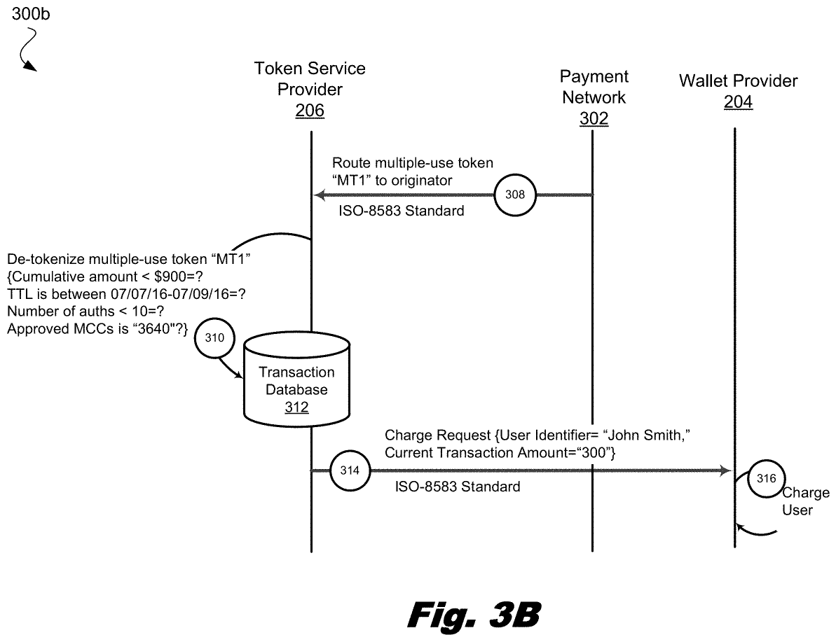

FIGS. 3A and 3B is an example process flow 300a, 300b for charging the user's digital wallet for the initial transaction. A charge to the user's digital wallet may also be referred to as a charge to a multiple-use token associated with the user's digital wallet. Process flow 300a, 300b shows interactions between merchant application 202, payment network 302, token service provider 206, and wallet provider 204 that lead to a funding instrument (e.g., the user's digital wallet) being charged for the initial transaction. The initial transaction involving the merchant may cause merchant application 202 to request a multiple-use token that is used to pay for the initial transaction with merchant application 202 along with transactions at the merchant's physical location.

In FIG. 3A, merchant application 202 stores information about multiple-use token “MT1” and the transactions associated with the multiple-use token (see action 236 in FIG. 2B). At an action 304, merchant application 202 routes the multiple-use token “MT1” stored in merchant database 238 to a payment network 302. Merchant application 202 routes the multiple-use token “MT1” to payment network 302 so that the originator of the multiple-use token may provide payment to the merchant for the initial transaction or may route the multiple-use token to an entity that may provide payment to the merchant for the initial transaction. The routing of the multiple-use token “MT1” at action 304 by merchant application 202 may be the first request to charge the user's digital wallet associated with the multiple-use token. In an example, the multiple-use token “MT1” is sent in an ISO-8583 message, which has specified fields. The merchant may be unaware that the TPAN is a proxy for the user's digital wallet and treats the TPAN like it were handling any other physical plastic card that is stored in the system. As such, the multiple-use token “MT1” may provide an extra layer of security for the user because it may be unnecessary for her to provide her credit card information or debit card information to merchant application 202. Rather, token service provider 206 may abstract these details from merchant application 202 and provide merchant application 202 with a TPAN that may not be understandable outside of the context of token service provider 206 or wallet provider 204.

Payment network 302 receives the multiple-use token “MT1” from merchant application 202 and routes transaction information associated with the multiple-use token in accordance with its account type. At action 306, payment network 302 identifies the routing details associated with the multiple-use token “MT1.” Process flow may proceed from action 306 in FIG. 3A to action 308 in FIG. 3B, at which payment network 302 routes the multiple-use token “MT1” back to its originator (token service provider 206) using the ISO-8583 standard. In an example, payment network 302 identifies the TPAN of the multiple-use token, and recognizes it as being generated by token service provider 206. For example, token service provider 206 is PAYPAL®, and payment network 302 may determine that the multiple-use token “MT1” is representative of a token issued by PAYPAL®.

Token service provider 206 receives the multiple-use token “MT1” that it previously generated (see action 230 in FIG. 2B) through the payment network 302. Accordingly, token service provider 206 knows that the user associated with the multiple-use token “MT1” is attempting to pay for a transaction. At action 310, token service provider 206 de-tokenizes the multiple-use token “MT1” by identifying transaction information in the token. Token service provider 206 may store the supplemental transaction data and information associated with the multiple-use token in a transaction database 312. In an example, token service provider 206 determines whether the multiple-use token “MT1” is valid in accordance with the online transaction and the set of policies defined for the multiple-use token. The set of policies may specify conditions or rules for the multiple-use token so that wallet provider 204 has special control of whether a transaction should be charged to the user's digital wallet. Accordingly, token service provider 206 and wallet provider 204 may be assured that the multiple-use token is not indefinite and does not live forever.

The process of de-tokenizing the multiple-use token may include validating the multiple-use token based on whether the set of policies corresponding to the token is satisfied. In response to a determination that at least one policy of the set of policies is not satisfied, token service provider 206 may determine that the multiple-use token is invalid and send an error message to user device 102. Additionally, if the multiple-use token is invalid, the user's digital wallet is not charged and the user may be requested to provide another form of payment (e.g., credit card or debit card) by merchant application 202. In contrast, in response to a determination that the set of policies is satisfied, token service provider 206 may determine that the multiple-use token is valid.

During the de-tokenization of the multiple-use token “MT1,” token service provider 206 may validate the multiple-use token based on whether its corresponding set of policies is satisfied. The set of policies may provide extra risk mediation to ensure that the multiple-use token is not “high-risk” and is valid such that the user's digital wallet associated with the multiple-use token should be charged.

In an example, a “cumulative amount” parameter is defined for the multiple-use token “MT1,” and token service provider 206 keeps track of a current sum of the transactions charged to the user's digital wallet corresponding to the multiple-use token “MT1.” Token service provider 206 may specify a policy that the current sum charged to the digital wallet associated with the multiple-use token does not exceed the maximum allowed amount for which the TPAN can be issued. Token service provider 206 may update the current sum associated with the multiple-use token and stored in transaction database 244 by increasing the current sum by an amount charged to the user's digital wallet associated with the multiple-use token and by decreasing the current sum by an amount credited for a returned good and/or service from the user's digital wallet associated with the multiple-use token. In an example, token service provider 206 determines that the multiple-use token is invalid in response to a determination that the current sum charged to a digital wallet associated with the multiple-use token exceeds the cumulative amount defined as a parameter of the multiple-use token.

In another example, “unit rate” and “overage” parameters are defined for the multiple-use token “MT1.” In an example, “Unit Rate=‘$150’” and “Overage=‘$600’” are parameters defined for the multiple-use token, and token service provider 206 calculates the cumulative amount as being $900 (Unit Rate×Total days of Service+Overage Amount).” The unit rate refers to the price per quantity of daily service. The overage amount refers to expected incidental charges and taxes. If a current sum does not exceed the cumulative amount, the policy is satisfied and the multiple-use token may be valid. If the current sum exceeds the cumulative amount, this policy is not satisfied, and thus the multiple-use token is invalid. Accordingly, the merchant may be prevented from using the multiple-use token to charge over a particular amount to the user's digital wallet.

In another example, a time element parameter is defined for the multiple-use token “MT1” and specifies the dates in which the multiple-use token may be valid. In an example, token service provider 206 specifies a policy that the current transaction date occurs before an expiration date (or TTL). If the current transaction date occurs after the expiration date, this policy is not satisfied, and thus the multiple-use token is invalid. It may be undesirable to allow the hotel merchant to use this multiple-use token long after the user has checked out of the hotel. In contrast, if the current transaction date occurs before the expiration date, this policy is satisfied and the multiple-use token may be valid. In this instance, a high likelihood exists that the user is still enjoying her stay at the hotel and has decided to make purchases at the hotel.

In an example, the following formula may determine the TTL:

TTL=x+Authorization period ceiling, where x=(Start date−Current Date +1), and the Authorization period ceiling=(End date−Start date+1+366+31). The Authorization period ceiling corresponds to the maximum time up to which the actual authorization for the transaction amount can come in. This formula is not intended to be limiting, and it should be understood that other formulas for calculating the TTL are also within the scope of the present disclosure.

In an example, token service provider 206 may specify a policy that the current transaction date is between a particular start date and a end date. The start date of service refers to the planned start date of service for which the requested transactable token will be used to authorize payment, and the end date of service refers to the planned end date of service for which the requested transactable token will be used to authorize payment. For example, if the TTL for the multiple-use token “MT1” is between Jul. 7, 2016 and Jul. 9, 2016 (e.g., “Start Date=‘Jul. 7, 2016,’ End Date=‘Jul. 9, 2016’”), inclusive, then token service provider 206 may determine whether the date of the current transaction falls within this range. If the current transaction date is on or between Jul. 7, 2016 and Jul. 9, 2016, this policy is satisfied and the multiple-use token may be valid. If the current transaction date falls outside of this range, this TTL policy is not satisfied, and thus the multiple-use token is invalid. Token service provider 206 may specify more than one start-and-end-date pair.

In an example, a “number of auths” parameter is defined for the multiple-use token “MT1,” and token service provider 206 keeps track of how many transactions have been charged to the user's digital wallet corresponding to the multiple-use token “MT1.” Token service provider 206 may update the current sum of authorized transactions associated with the multiple-use token and stored in transaction database 244 by increasing the current sum of authorized transactions by one each time a transaction is charged to the user's digital wallet associated with the multiple-use token. In an example, token service provider 206 determines that the multiple-use token is invalid in response to a determination that the current sum of authorized transactions charged to a digital wallet associated with the multiple-use token exceeds the number of authorizations defined as a parameter of the multiple-use token.

In another example, a “list of approved MCCs” parameter is defined for the multiple-use token “MT1,” and token service provider determines whether the merchant involved in the current transaction is assigned an MCC specified in the list of approved MCCs for which the issued TPAN may be successfully authorized. Each merchant may belong to a particular MCC, which is typically a number assigned to a business by a company (e.g., credit card company or payment service provider) to identify the type of business in which the merchant is engaged. For example, the hotel merchant's MCC may be “3640,” and “list of approved MCC's may include “3640,” which specifies that the merchant is a hotel. If the current transaction does not involve a merchant assigned to MCC “3640,” this policy is not satisfied, and thus the multiple-use token is invalid. For example, it may be desirable to prevent a merchant in the airline industry (versus a merchant in the hotel industry) from using this multiple-use token to complete a transaction if the multiple-use token was initially generated for a hotel merchant. In contrast, if the current transaction involves a merchant assigned to MCC “3640,” this policy is satisfied and the multiple-use token may be valid. Token service provider 206 may specify more than one MCC for a multiple-use token.

These are merely examples, and the multiple-use token may be associated with other policies that may be used to validate the multiple-use token. For example, token service provider 206 may specify a policy that the merchant's name associated with the current transaction matches the merchant's business name originally included in action 222 in FIG. 2B. The merchant's business name refers to the preferred name that the merchant wishes to have displayed to a user. In keeping with the above example, if the merchant's name associated with the current transaction matches the “Hotel Co.,” this policy is satisfied and the multiple-use token may be valid. If the merchant's name associated with the current transaction does not match the “Hotel Co.,” this policy is not satisfied, and thus the multiple-use token is invalid.

In another example, token service provider 206 specifies a policy that the location of the current transaction occurs within 100 miles of the merchant's location, which may be in Washington, D.C. If this policy is satisfied, the multiple-use token may be valid; otherwise, the multiple-use token is invalid. The use of multiple-use tokens may have some advantages in terms of security. For example, the multiple-use token may be associated with the merchant's location in Washington, D.C. If a transaction occurred in California between the start and end dates, payment server 208 may flag this activity as risky because the user is expected to be in Washington, D.C.

If token service provider 206 de-tokenizes the multiple-use token and determines that it is valid, token service provider 206 may push the transaction information associated with the current transaction to wallet provider 204 for charging. Token service provider 206 and/or wallet provider 204 may update supplemental transaction data in accordance with the online transaction (e.g., update the transaction sum associated with a multiple-use token) if the online transaction is approved for payment by the user's digital wallet. Additionally, token service provider 206 and/or wallet provider 204 may update the supplemental transaction data in accordance with one or more approved transaction authorization requests associated with the multiple-use token.

If token service provider 206 determines that the multiple-use token is valid, process flow may proceed from action 310 to action 314, in which token service provider 206 sends a charge request to wallet provider 204. The charge request includes transaction information based on de-tokenizing the multiple-use token “MT1.” For example, the charge request specifies a user identifier that identifies the user (“John Smith”) and a current transaction amount (“300”). Wallet provider 204 receives the charge request and determines whether to authorize the charge the current transaction amount to the user's digital wallet. If wallet provider 204 determines to reject the charge to the user's digital wallet, wallet provider 204 may send a reject message to the merchant, which may request the user to provide another form of payment to complete the transaction. Wallet provider 204 may reject the charge for various reasons. For example, wallet provider 204 may reject the charge if the user removed all funding instruments from her digital wallet or the user's digital wallet account is frozen. In contrast, if wallet provider 204 determines to authorize the charge to the user's digital wallet, process flow proceeds to action 316, at which wallet provider 204 charges the user's digital wallet. For example, in response to a determination that the multiple-use token is valid in accordance with the online transaction and the set of policies defined for the multiple-use token, wallet provider 204 charges the digital wallet in accordance with the online transaction. Charging the digital wallet in accordance with the online transaction may include charging the transaction amount of the online transaction to the digital wallet. Wallet provider 204 may send a message indicating that the transaction has been approved and paid to the user device.

The user's digital wallet includes one or more payment methods. Charging the user's digital wallet may also refer to charging a payment method within the user's digital wallet. In an example, wallet provider 204 may select a payment method within the user's digital wallet to charge for the current transaction. In an example, wallet provider 204 selects a default payment method within the digital wallet specified by the user. In an example, the selected payment method within the user's digital wallet is the user's account balance with wallet provider 204 (e.g., VENMO® account balance). In another example, the selected payment method within the user's digital wallet is the user's credit card identified by “V-4567.” In this example, wallet provider 204 may charge the user's credit card identified by “V-4567” by sending the credit card details (e.g., credit card number, security code, etc.) to payment network 302 for routing to the issuer of the credit card. In another example, the selected payment method within the user's digital wallet is a debit card. In this example, wallet provider 204 may charge the user's debit card by sending the debit card details (e.g., debit card number, expiration date, etc.) to payment network 302 for routing to the issuer of the debit card. In another example, the selected payment method within the user's digital wallet is the user's checking account. In this example, wallet provider 204 may charge the user's checking account.

In some examples, the merchant partners with wallet provider 204 to provide offerings to the user. In an example, the merchant and wallet provider 204 may provide joint offers to the user. For example, the merchant may provide the user with a discount (e.g., 10 percent off) if the user books her reservation through wallet provider 204.

Although a hotel merchant is described in the above example, this is not intended to be limiting and it should be understood that any merchant type may be used. For example, the merchant may be a car rental merchant, an airline, etc. As discussed, a merchant that allows a user to book a reservation online and expects the user to have incidental charges (e.g., car insurance, gas fill-up, etc.) may benefit from the use of multiple-use tokens to process the merchant's transactions.

As discussed, the multiple-use token may be used multiple times for different transactions. For example, the multiple-use token may be generated for the user's online hotel booking, and then subsequently used during the user's hotel stay. Accordingly, this multiple-use token may be used at the merchant's physical location, even though the merchant's point of sales terminals do not explicitly offer the user the option of using her digital wallet provided by wallet provider 204. When the user arrives at the hotel, the hotel has the multiple-use token information on file and may use the multiple-use token information stored in merchant database 238 to pay for one or more of the user's transactions during her hotel stay. Accordingly, the present disclosure provides techniques to meet the needs of existing industries, without requiring these industries to purchase additional resources. Without the teachings provided in the present disclosure, the merchant may otherwise not be able to charge the user's digital wallet when the user arrives at the merchant's location to consume additional goods and/or services outside of the initial booking. The multiple-use token is a tokenized version of a payment card that appears to be a wallet (e.g., credit card or debit card).

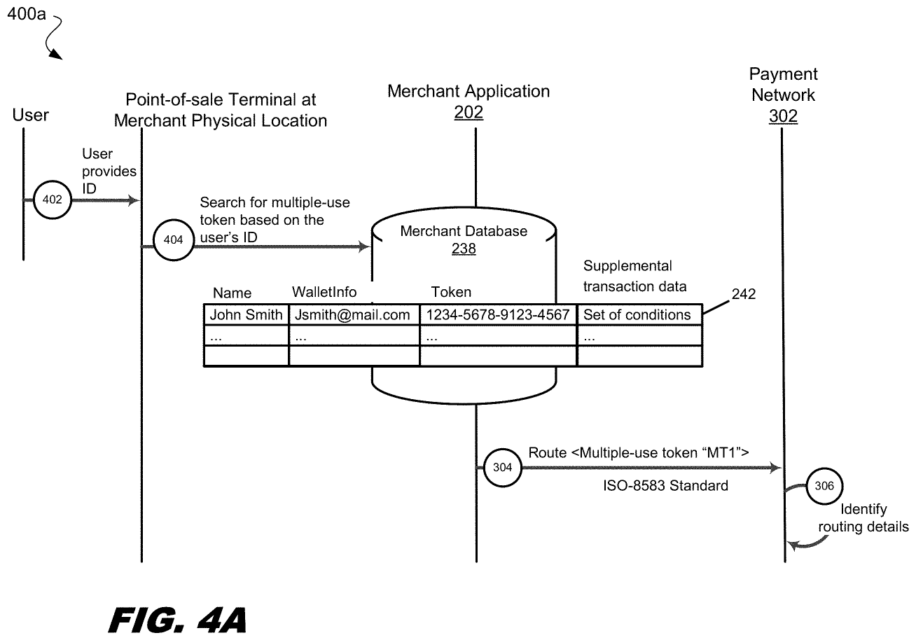

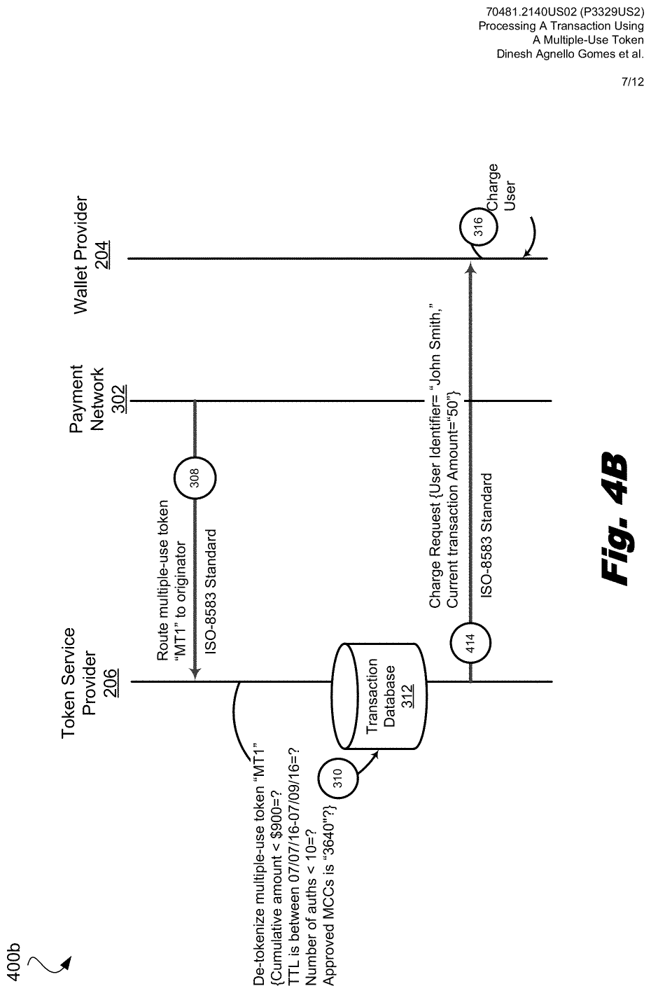

FIGS. 4A and 4B is an example process flow 400a, 400b for charging the user's digital wallet based on a transaction subsequent to the initial booking transaction. Process flow 400a, 400b shows interactions between the user, a point-of-sale terminal at the merchant's physical location, merchant application 202, and payment network 302 that lead to the user's digital wallet being charged for a second transaction. Process flow 400a, 400b may be performed each time the user desires to pay using her digital wallet at the merchant's location.

In FIG. 4A, the current transaction amount may be $50, which is the cost of the user's dinner at the hotel. At action 402, a user provides an ID to a merchant's representative at the merchant's physical location. The user may ID herself to the merchant's representative or the point-of-sale terminal so that the merchant may charge the user's “card” that the merchant has on file. The card may be identified by a TPAN issued by token service provider 206 and corresponding to the multiple-use token “MT1.” Merchant application 202 stores information about the multiple-use token and the transactions associated with the multiple-use token. At action 404, the merchant's terminal (e.g., point-of-sale terminal) searches for the multiple-use token based on the user's ID. For example, the user may provide his name to an employee of the merchant for searching, and the merchant's employee may enter “John Smith” into the terminal. The terminal may query merchant database 238 and identify the multiple-use token included in entry 242 based on the user's name. In another example, the user may provide his email address to an employee of the merchant for searching, and the merchant's employee may enter “Jsmith@mail.com” into the terminal. The terminal may query merchant database 238 and identify the multiple-use token included in entry 242 based on the user's email address. In another example, the user may provide his room number to an employee of the merchant for searching, and the merchant's employee may enter the user's room number into the terminal. The terminal may pull up the reservation, identify the name listed on the reservation, and query merchant database 238 to identify the multiple-use token included in entry 242 based on the user's name.

The multiple-use token was generated based on an initial transaction and is stored at merchant database 238 for use in other transactions. In the above example, the initial transaction is the hotel booking. The point-of-sale terminal may find the multiple-use token associated with the initial transaction and route the multiple-use token to payment network 302. In an example, merchant application 202 uses routes the multiple-use token in an ISO-8583 message. It should also be understood that messages described using an ISO-8583 standard may be sent using other mechanisms (e.g., invocation of an API).

In FIG. 4A, process flow proceeds from action 404 to action 304 and then to action 306, which were discussed in relation to FIG. 3A. After action 306 in FIG. 4A, process flow proceeds from action 306 to actions 308, 310, and 414 in FIG. 4B. At action 414, token service provider 206 sends a charge request including the user identifier and current transaction amount to wallet provider 204. At action 316, wallet provider 204 charges the current transaction amount to the user's digital wallet if the de-tokenized multiple-use token “MT1” satisfies the corresponding set of policies.

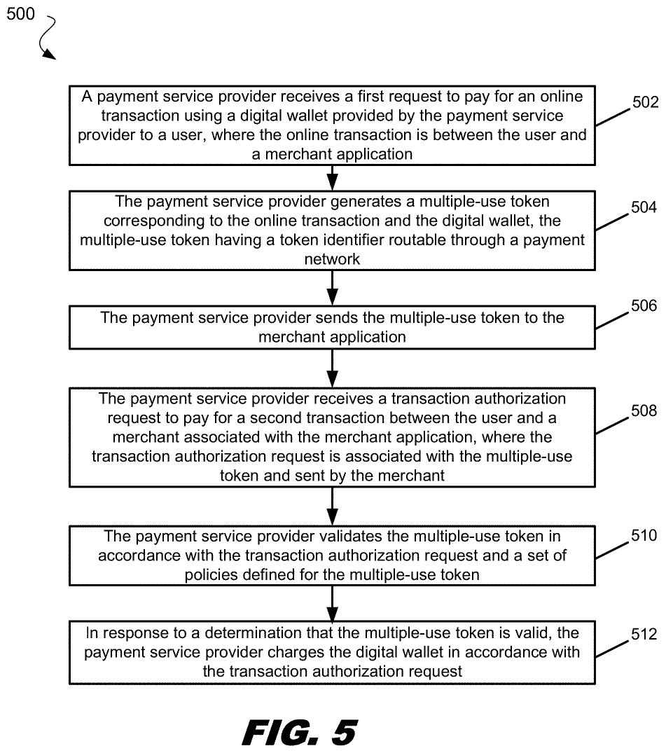

FIG. 5 is a flowchart illustrating an example method 500 of processing a multiple-use token. Method 500 is not meant to be limiting and may be used in other applications other than the payment applications discussed below. Method 500 includes steps 502, 504, 506, 508, 510, and 512.

In step 502, a payment service provider receives a first request to pay for an online transaction using a digital wallet provided by the payment service provider to a user, where the online transaction is between the user and a merchant application. In some examples, a payment service provider (e.g., PAYPAL®) that is represented to the merchant as an email address is not inherently network routable by the existing card payment networks. The email address may be a container for other payment methods such as credit card(s), debit card(s), and bank account(s).

In step 504, the payment service provider generates a multiple-use token corresponding to the online transaction and the digital wallet, the multiple-use token having a token identifier routable through a payment network. In step 506, the payment service provider sends the multiple-use token to the merchant application. In a step 508, the payment service provider receives a transaction authorization request to pay for a second transaction between the user and a merchant associated with the merchant application, where the transaction authorization request is associated with the multiple-use token and sent by the merchant. In a step 510, the payment service provider validates the multiple-use token in accordance with the transaction authorization request and a set of policies defined for the multiple-use token. In a step 512, in response to a determination that the multiple-use token is valid, the payment service provider charges the digital wallet in accordance with the transaction authorization request.

It should be understood that additional processes may be performed before, during, or after steps 502, 504, 506, 508, 510, and/or 512 discussed above. It is also understood that one or more of the steps of method 500 described herein may be omitted, combined, or performed in a different sequence as desired.

Unless specifically stated otherwise, as apparent from the following discussion, it is appreciated that throughout the description, discussions utilizing terms such as “receiving”, “sending”, “storing”, “providing”, “determining”, “generating,” “receiving,” “validating,” “authenticating,” “rejecting,” “searching,” “obtaining,” “routing,” “sending,” “identifying,” “charging,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

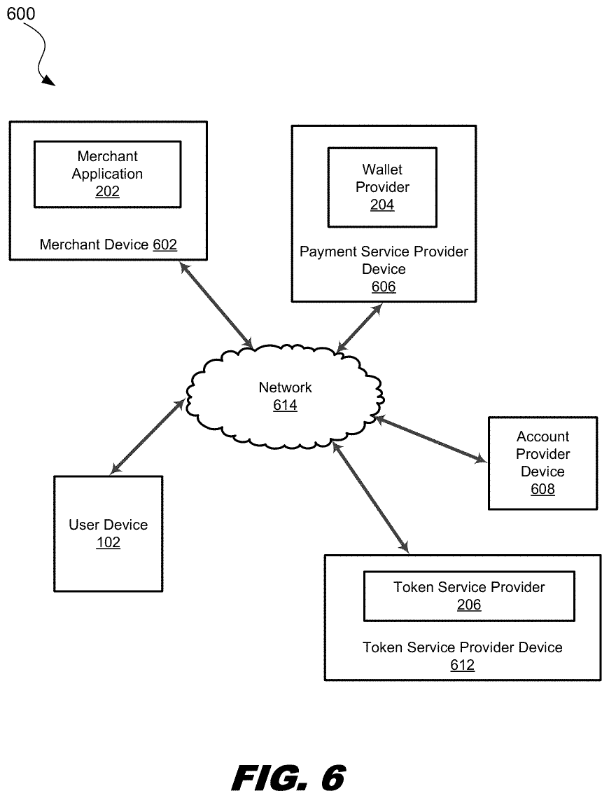

Referring now to FIG. 6, an embodiment of a network-based system 600 for implementing one or more processes described herein is illustrated. As shown, network-based system 600 may include or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 6 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of networked system 600 illustrated in FIG. 6 includes one or more user devices 102, one or more merchant devices 602, one or more payment service provider devices 606, one or more account provider devices 608, and/or one or more token service provider devices 612 in communication over a network 614. Any of the user devices 102 may be the user devices, discussed above, and may be operated by the users discussed above. Merchant devices 602 may be the merchant devices discussed above and may be operated by the merchants discussed above. Merchant device 602 may store merchant application 202. Payment service provider devices 606 may be operated by the payment service provider described above. Payment service provider device 606 may store payment server 208.

Account provider devices 608 may be the account provider devices discussed above and may be operated by the payment service provider (e.g., wallet provider) discussed above. Account provider device may provide an account of the payment service provider to the user. Additionally, token service provider device 612 may be a device that provides token service provider 206 discussed above, and provides these services to other entities. Token service provider 206 may be operated by, for example, PAYPAL®.

The one or more user devices 102, one or more merchant devices 602, one or more payment service provider devices 606, one or more account provider devices 608, and/or one or more token service provider devices 612 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 600, and/or accessible over the network 614.

The network 614 may be implemented as a single network or a combination of multiple networks. For example, in various embodiments, the network 614 may include the Internet and/or one or more intranets, landline networks, wireless networks, and/or other appropriate types of networks.

The user devices 102 may be implemented using any appropriate combination of hardware and/or software configured for wired and/or wireless communication over network 614. For example, in one embodiment, the user devices 102 may be implemented as a personal computer of a user in communication with the Internet. In other embodiments, the user devices 602 may be a smart phone, personal digital assistant (PDA), laptop computer, and/or other types of computing devices. The user devices 102 may include one or more browser applications which may be used, for example, to provide a convenient interface to permit the user to browse information available over the network 614. For example, in one embodiment, the browser application may be implemented as a web browser configured to view information available over the Internet. The user devices 102 may also include one or more toolbar applications which may be used, for example, to provide user-side processing for performing desired tasks in response to operations selected by the user. In one embodiment, the toolbar application may display a user interface in connection with the browser application.

The user devices 102 may further include other applications as may be desired in particular embodiments to provide desired features to the user devices 102. In particular, the other applications may include a payment application for payments assisted by a payment service provider through the payment service provider device 606. The other applications may also include security applications for implementing user-side security features, programmatic user applications for interfacing with appropriate application programming interfaces (APIs) over the network 614, or other types of applications. Email and/or text applications may also be included, which allow the user to send and receive emails and/or text messages through the network 614. The user devices 102 may include one or more user and/or device identifiers which may be implemented, for example, as OS registry entries, cookies associated with the browser application, identifiers associated with hardware of the user devices 102, or other appropriate identifiers, such as a phone number. In one embodiment, the user identifier may be used by the payment service provider device 606 and/or account provider devices 608 to associate the user with a particular account (e.g., the account associated with a digital wallet) as further described herein.

The merchant devices 602 may be maintained, for example, by a conventional or on-line merchant, conventional or digital goods seller, individual seller, and/or application developer offering various products and/or services in exchange for payment to be received conventionally or over the network 614. In this regard, the merchant devices 604 (e.g., point-of-sale terminals) may include a database identifying available products and/or services (e.g., collectively referred to as items) which may be made available for viewing and purchase by the user. The merchant devices 602 may also include a checkout application which may be configured to facilitate the purchase by the payer of items. The checkout application may be configured to accept payment information from the user through the user devices 102, the account providers through the account provider devices 608, and/or from the payment service provider through the payment service provider device 606 over the network 614.

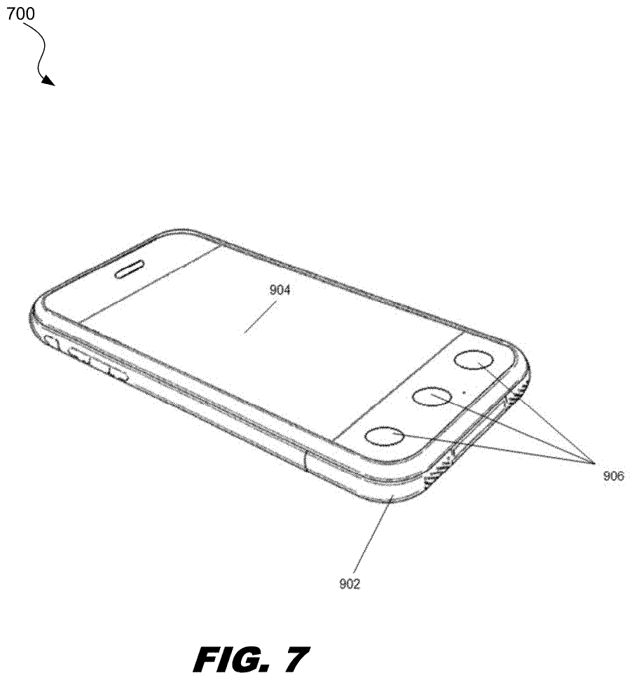

Referring now to FIG. 7, an embodiment of a user device 700 is illustrated. The user device 700 may be any of the user devices discussed above. The user device 700 includes a chassis 902 having a display 904 and an input device including the display 904 and a plurality of input buttons 906. One of skill in the art will recognize that the user device 600 is a portable or mobile phone including a touch screen input device and a plurality of input buttons that allow the functionality discussed above with reference to the method 500. However, a variety of other portable/mobile user devices and/or desktop user devices may be used in the methods discussed above without departing from the scope of the present disclosure.

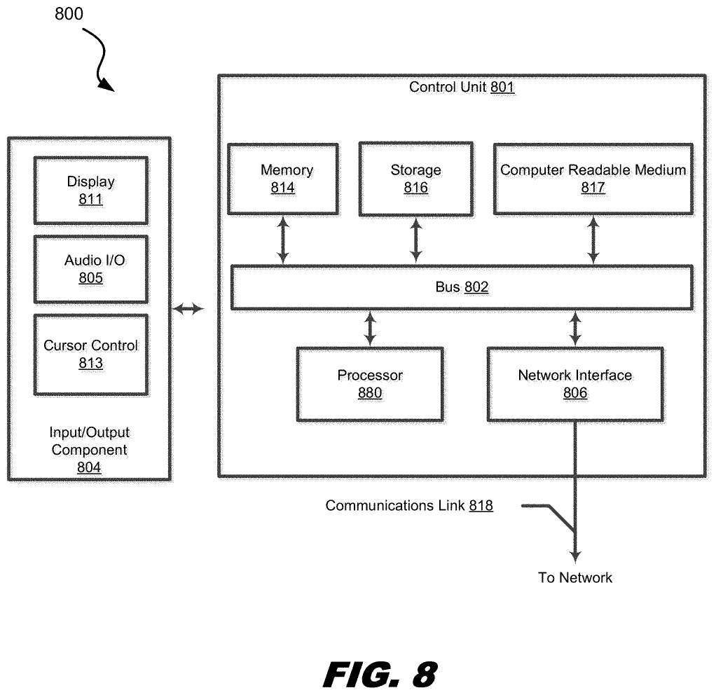

FIG. 8 is a block diagram of a computer system 800 suitable for implementing one or more embodiments of the present disclosure. In various implementations, merchant device 602, payment service provider device 606, account provider device 608, and/or token service provider device 612 may be a client or a server computing device. The client or server computing device may include one or more processors. The client or server computing device may additionally include one or more storage devices each selected from a group including a floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read. The one or more storage devices may include stored information that may be made available to one or more computing devices and/or computer programs (e.g., clients) coupled to the client or server using a computer network (not shown). The computer network may be any type of network including a LAN, a WAN, an intranet, the Internet, a cloud, and/or any combination of networks thereof that is capable of interconnecting computing devices and/or computer programs in the system.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons or links, etc., and sends a corresponding signal to bus 802. I/O component 804 may also include an output component such as a display 811, and an input control such as a cursor control 813 (such as a keyboard, keypad, mouse, etc.). In an example, page 100 in FIG. 1 may be displayed on display 811. An audio input/output component 804 may also be included to allow a user to use voice for inputting information by converting audio signals into information signals. Audio I/O component 805 may allow the user to hear audio.

A transceiver or network interface 806 transmits and receives signals between computer system 800 and other devices via a communications link 818 to a network. In an embodiment, the transmission is wireless, although other transmission mediums and methods may also be suitable. A processor 880, which may be a micro-controller, digital signal processor (DSP), or other processing component, processes these various signals, such as for display on computer system 800 or transmission to other devices via communications link 818. Processor 880 may also control transmission of information, such as cookies or IP addresses, to other devices.

Components of computer system 800 also include a system memory component 814 (e.g., RAM), a static storage component 816 (e.g., ROM), and/or a computer readable medium 817. Computer system 800 performs specific operations by processor 880 and other components by executing one or more sequences of instructions contained in system memory component 814. Logic may be encoded in a computer readable medium, which may refer to any medium that participates in providing instructions to processor 880 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 814, and transmission media includes coaxial cables, copper wire, and fiber optics, including wires that include bus 802. In an embodiment, the logic is encoded in non-transitory computer readable medium. In an example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences (e.g., process flow 200a, 200b, process flow 300a, 300b, process flow 400, and/or method 500) to practice the present disclosure may be performed by computer system 800. In various other embodiments of the present disclosure, a plurality of computer systems 800 coupled by communications link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

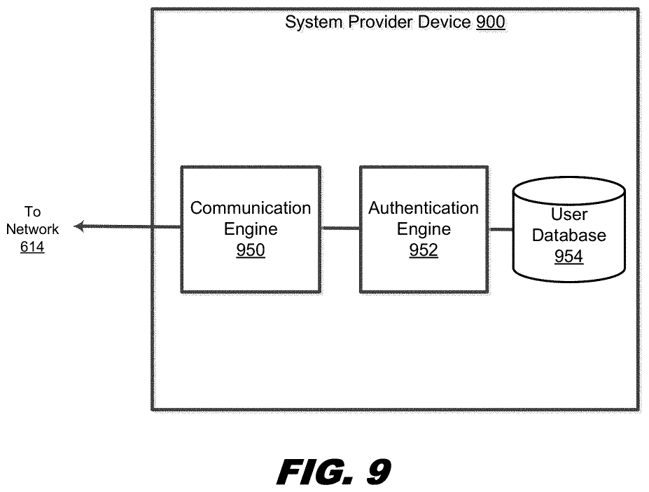

Referring now to FIG. 9, an embodiment of a system provider device 900 is illustrated. In an embodiment, the device 900 may be the user devices, the merchant devices, the payment service provider device, the account provider devices, and/or the token service provider device discussed above. The device 9800 includes a communication engine 950 that is coupled to the network 614 and to an authentication engine 952 that is coupled to a user database 954. The communication engine 950 may be software or instructions stored on a computer-readable medium that allows the device 900 to send and receive information over the network 614. The authentication engine 952 may be software or instructions stored on a computer-readable medium that is operable to provide any of the other functionality that is discussed above. While the database 954 has been illustrated as located in the device 900, one of skill in the art will recognize that it may be connected to authentication 952 through the network 614 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

1. (canceled)

2. A method for using multiple-use tokens, the method comprising:
receiving, by a merchant device, a wallet use request from a user device, the wallet use request to use a certain payment source when processing a transaction between the user device and the merchant device;
communicating, by the merchant device and with a wallet provider, to obtain a multiple-use token, the wallet use request comprising a set of policies associated with use restrictions on use of the multiple-use token, the multiple-use token for use in one or more transactions between a user device and the merchant device, the one or more transactions using a digital wallet provided by the wallet provider, the digital wallet using one or more payment services for processing the transaction;
storing, on a storage device associated with the merchant device, the multiple-use token that indicates the associated set of policies, the associated set of policies for determining whether the use restrictions allow one of the payment services to be used for the transaction; and
provide the multiple-use token to a payment network for processing the transaction.

3. The method of claim 2, wherein said communicating comprises sending a first request comprising a set of policies associated with use restrictions on use of the multiple-use token.

4. The method of claim 2, further comprising:
responsive to receiving a user request comprising a user ID and a transaction ID, initiating a new transaction using the multiple-use token, said initiating based on matching the user ID with a stored plurality of multiple-use tokens to select the multiple-use token, said initiating comprising communicating with a payment network using the multiple-use token.

5. The method of claim 2, wherein
the multiple-use token corresponds to a certain payment source for use at a payment network;
the multiple-use token is associated with the certain payment source at a payment provider; and
the merchant device does not expose the certain payment source to the user device.

6. The method of claim 2, wherein the multiple-use token is referenced using a token identifier that includes a primary account number routable by the payment network to an originator of the multiple-use token.

7. The method of claim 2, wherein the set of policies is used by the payment network with a token service provider for validating in accordance with the transaction and the set of policies defined for the multiple-use token.

8. The method of claim 2, the method further comprising:
communicating with the wallet provider to authenticate the user based on user's login credentials, wherein the wallet use request includes login credentials of the user.

9. The method of claim 2, further comprising:
communicating with a token service provider to update supplemental transaction data in accordance with the transaction;
updating, by the merchant device, locally stored supplemental transaction data in accordance with one or more approved transaction authorization requests associated with the multiple-use token.

10. A merchant device, comprising:
a non-transitory memory storing instructions; and
a processor configured to execute the instructions to cause the device to:
receive a user request for processing a transaction using a processing network, the user request comprising a user ID and a transaction ID,
responsive to receiving the user request, access a plurality of multiple-use tokens to match a multiple-use token based on the user ID, each of the plurality of multiple-use tokens associated with a respective set of policies indicating use restrictions on use of a respective one of the plurality of the multiple-use tokens, each of the plurality of multiple-use tokens for use in transactions between a user device and one of merchant devices including the merchant device, the transactions using a digital wallet provided by the wallet provider and associated with a user of the user device, the digital wallet using one or more payment services for processing the transaction; and
initiate a new transaction using the multiple-use token, said initiating comprising communicating with a payment network using the multiple-use token to process the transaction.

11. The merchant device of claim 10, wherein
the multiple-use token corresponds to a certain payment source for use at a payment network;
the multiple-use token is associated with the certain payment source at a payment provider; and
the merchant device does not expose the certain payment source to the user device.

12. The merchant device of claim 10, wherein the multiple-use token is referenced using a token identifier that includes a primary account number routable by the payment network to an originator of the multiple-use token.

13. The merchant device of claim 10, wherein the set of policies is used by the payment network with a token service provider for validating in accordance with the transaction and the set of policies defined for the multiple-use token.

14. The merchant device of claim 10, the method further comprising:
communicating with the wallet provider to authenticate the user based on user login credentials that are associated with the user request, wherein the wallet use request includes login credentials of the user.

15. The merchant device of claim 10, wherein executing the instructions further causes the device to,
communicate with a token service provider to update supplemental transaction data in accordance with the transaction;
update, by the merchant device, locally stored supplemental transaction data in accordance with one or more approved transaction authorization requests associated with the multiple-use token.

16. A non-transitory machine-readable medium having instructions stored thereon, the instructions executable to cause performance of operations comprising:
receiving, by a merchant device, a wallet use request from a user device, the wallet use request to use a certain payment source when processing a transaction between the user device and the merchant device;
communicating, by the merchant device and with a wallet provider, to obtain a multiple-use token, the wallet use request comprising a set of policies associated with use restrictions on use of the multiple-use token, the multiple-use token for use in one or more transactions between a user device and the merchant device, the one or more transactions using a digital wallet provided by the wallet provider, the digital wallet using one or more payment services for processing the transaction;
storing, on a storage device associated with the merchant device, the multiple-use token that indicates the associated set of policies, the associated set of policies for determining whether the use restrictions allow one of the payment services to be used for the transaction; and
provide the multiple-use token to a payment network for processing the transaction.

17. The non-transitory machine-readable medium of claim 16, wherein the multiple-use token is referenced using a token identifier that includes a primary account number routable by the payment network to an originator of the multiple-use token.

18. The non-transitory machine-readable medium of claim 16, wherein the operations further comprise:
responsive to receiving a user request comprising a user ID and a transaction ID, initiating a new transaction using the multiple-use token, said initiating based on matching the user ID with a stored plurality of multiple-use tokens to select the multiple-use token, said initiating comprising communicating with a payment network using the multiple-use token.

19. The non-transitory machine-readable medium of claim 16, wherein
the multiple-use token corresponds to a certain payment source for use at a payment network;
the multiple-use token is associated with the certain payment source at a payment provider; and
the merchant device does not expose the certain payment source to the user device.

20. The non-transitory machine-readable medium of claim 16, wherein the set of policies is used by the payment network with a token service provider for validating in accordance with the transaction and the set of policies defined for the multiple-use token.

21. The non-transitory machine-readable medium of claim 16, wherein the operations further comprise:
communicating with a token service provider to update supplemental transaction data in accordance with the transaction;
updating, by the merchant device, locally stored supplemental transaction data in accordance with one or more approved transaction authorization requests associated with the multiple-use token.
